(19) United States
(12) Patent Application Publication
(10) Pub. No.: US 2020/0216651 A1
(43) Pub. Date: Jul. 9, 2020

(54) LIGHTWEIGHT, HIGH-TOUGHNESS, HIGH-RIGIDITY POLYPROPYLENE COMPOSITION AND MANUFACTURING METHOD THEREOF

(71) Applicant: NAN YA PLASTICS CORPORATION, Taipei (TW)

(72) Inventors: Te-Chao LIAO, Taipei (TW); Han-Ching HSU, Taipei (TW); Chun-Lai CHEN, Taipei (TW); Kai-Chi LEI, Taipei (TW); Shaw-Chun CHIANG, Taipei (TW)

(21) Appl. No.: 16/238,643

(22) Filed: Jan. 3, 2019

(51) Int. Cl. C08L 23/12; C08J 3/22

(52) U.S. Cl. CPC C08L 23/12; C08J 3/226; C08L 2205/025; C08L 2310/00; C08L 2205/035; C08L 2201/08; C08L 2205/08

(57) ABSTRACT

A polypropylene composition provided with lightweight, highly tough and highly rigid as well as having a specific weight of 1.0-1.05 is made of a polypropylene resin, inorganic powder, a toughener, a coupling agent, a compatibilizer and an anti-oxidant; a method of manufacturing the composition involves grafting the inorganic powder onto the polypropylene resin and the coupling agent to form a masterbatch, and mixing the masterbatch with the other additives to enhance bonding ability of the inorganic powder inside the polypropylene composition to endow the composite with good toughness, rigidity and mobility, and reducing undesirable dust.

### BACKGROUND OF THE INVENTION

### 1. Field of the Invention

The present invention relates to polypropylene compositions, and more particularly to a lightweight polypropylene composition that has a specific weight below 1.05, and is suitable for large components such as doors, windows, automotive parts and housings of home appliances due to its high toughness and high rigidity.

### 2. Description of Related Art

Plastic forms a range of the most popular non-metallic materials, and is extensively used in various applications, including doors, windows, automotive parts and components as well as diverse containers.

Among plastic materials, polyolefin resins are desirable for having low specific weights, low prices, and good toughness. However, the development of new polyolefin composites is often subject to the difficulty in reaching good balance among different physical properties. Particularly, when used as materials for producing large components such as automotive bumpers and housings of home appliances through injection molding, polyolefin composites need to be lightweight and properly mobile.

The physical quantities to be considered for evaluation of plastic materials include impact strength (toughness) and flexural modulus (rigidity), which are two conflicting properties. That is, a highly rigid plastic material is not the one having excellent toughness. On the contrary, a highly tough plastic material cannot have excellent rigidity. Therefore, during formation of composites, rubber or inorganic materials may be added as a solution for modification.

To give a polypropylene composite with a high rigidity modulus, inorganic materials may be introduced in an enhanced amount. For example, polyethylene and styrene-butadiene rubber may be introduced with an inorganic filler such as calcium carbonate to achieve improved toughness in the resulting polypropylene composite. Alternatively, elastomer, ultra-high molecular weight polyethylene, or low-density linear polyethylene may be used to for toughening modification of the resulting polypropylene composite. However, this can increase the specific weight of the resulting polypropylene composite, and is against the trend toward lightweightness.

In addition, toughening modification for polypropylene composites as performed in the prior art out no extra attention to the overall mobility of the resulting polypropylene composites. While an addition of the elastomer greater than 10% of the total weight of the polypropylene composite does effectively improve the polypropylene composite in terms of toughness and in turn impact strength, the high viscosity of the elastic rubber unavoidably makes the resulting composition less mobile.

### SUMMARY OF THE INVENTION

The primary objective of the present invention is to provide a lightweight, high-toughness, high-rigidity polypropylene composition, which is made with a compatibilizer introduced that is made by grafting polypropylene on maleic anhydride. The compatibilizer not only improves interfacial bonding between inorganic powder and the polypropylene composition, but also endows the polypropylene composition with excellent resistance to impact (high toughness), good flexural modulus (high rigidity) and proper mobility for processing. With the ingredients introduced in a properly arranged order, the resulting polypropylene composition that has good balance among lightweightness, toughness and rigidity, thereby satisfying the need unmet in the prior art for a polypropylene composition that is lightweight and tough, yet rigid enough.

Also provided by the present invention is a manufacturing method of the foregoing polypropylene composition. The method includes first preparing a masterbatch by grafting inorganic powder and a coupling agent on a polypropylene resin, and extruding the masterbatch so that the coupling agent is cross-linked to the surface of the inorganic powder to enhance affinity among macromolecules; and melting and extruding the masterbatch together with the polypropylene resin and other additives, so as to obtain the polypropylene composition that has good balance among lightweightness, toughness and rigidity

More particularly, the inorganic powder used in the present invention has been mixed with a polypropylene resin and a coupling agent into masterbatch in advance, so that the inorganic powder disperses well in the polypropylene composition.

Another objective of the present invention is to provide a lightweight, high-toughness, high-rigidity polypropylene composition, having a specific weight ranging between 1.0 and 1.05, and being characterized in having a flexural modulus at 23° C. of 1832-2038 MPa as measured according to standards as set forth in ISO178 and 179, and simply supported beam notch impact strength of 40.2-55.8 kJ/m², and being composed of the following components in amounts based on and jointly amount to 100 wt % of a total weight of the polypropylene composition:
a) a polypropylene resin taking up 70-85 wt % and comprising based on a total weight of the poly propylene resin:
   a-1) 75-96% of a high-melting-index propylene-ethylene copolymer that has a melt flow index (MI) of 30-60 g/10 min. at 230° C. and with a load of 2.16 kg; and
   a-2) 4-25% of a low-melting-index propylene-ethylene copolymer that has a melt flow index (MI) of 1-20 g/10 min. at 230° C. with a load of 2.16 kg;
b) inorganic powder taking up 10-20 wt % and having an average grain diameter ranging between 0.01 and 20 μm;
c) high length-diameter ratio magnesium sulfate whisker taking up 3-6 wt %, and having a length-diameter ratio of 10-60;
d) a toughener taking up 1-5 wt %;
e) a coupling agent taking up 0.5-1 wt %;
f) a compatibilizer taking up 0.2-0.5 wt %, and being one made by grafting polypropylene on maleic anhydride; and
g) an anti-oxidant taking up 0.1-0.2 wt %.

The manufacturing method of polypropylene compositions of the present invention comprises the following steps:
1) at low speed mixing fine-particle-size inorganic powder with high length-diameter ratio inorganic powder in a mixer into a mixture, and dropwise adding a coupling agent to the mixture to well treat the surface of the mixture;
2) introducing the pretreated inorganic powder of step 1) with a high-melting-index polypropylene resin by weight of 1.5 times of the inorganic powder into a twin-screw extruder to produce a masterbatch;
3) well mixing the masterbatch of step 2) with an additional high-melting-index polypropylene, a low-melting-index polypropylene, a toughener, a compatibilizer and an anti-oxidant in a slow-speed mixer, feeding the mixture into a charging hopper of the twin-screw extruder, melting and extruding, cooling and granulating the mixture to obtain the polypropylene composition that has good balance among lightweightness, toughness and rigidity.

### DETAILED DESCRIPTION OF THE INVENTION

According to the present invention, a novel polypropylene composition is made by mixing and coextruding a polypropylene resin with additives. Therein, the polypropylene resin is a propylene-ethylene copolymer, which has a content of comonomer ethylene ranging between 1 and 10 wt %. Its mobility is expressed as a melt flow index (or MI) tested with parameters of 230° C. and 2.16 kg. The selection of MI is made with the consideration to molding processability and mechanical properties of the final product. The greater the molecular weight a polypropylene resin has, the smaller the MI and the poorer the mobility it has, making it unsuitable for injection molding. A polypropylene resin with an excessively great MI has poor toughness and is brittler. A proper MI range of the polypropylene resin is 0.5-100 g/10 min. In the present invention, the polypropylene resin used comprises 75-96 wt % of a propylene-ethylene copolymer having an MI of 30-60 g/10 min and 4-25 wt % of a propylene-ethylene copolymer having an MI of 1-20 g/10 min.

The inorganic powder in the polypropylene composition of the present invention is selected from spherical or irregular talcum, mica, and calcium carbonate.

Alternatively, it may be inorganic compound whisker, such as one or more of silicon carbide, magnesium oxide, silicon oxide, magnesium sulfate and calcium sulfate. The inorganic powder has received surface treatment or surface finish to have improved processability and physical properties. The inorganic powder has an average grain diameter ranging between 0.01 and 20 μm. Therein, the fine-particle-size inorganic powder is added in an amount of 10-20 wt %, and any adding amount greater than 20 wt % can make the composition to sticky to easily process. High length-diameter ratio inorganic powder is added in an amount of 3-6 wt %, and any adding amount greater than 6 wt % can make the final product have rough surface.

The fine-particle-size inorganic powder is talcum powder. Therein, the talcum powder has an average grain diameter of 0.1-3l m and is selected from fine-mesh talcum powder. It is used to improve the polypropylene composition in terms of rigidity. Generally, the talcum powder is added in the composition with an amount higher than 10 wt % because any adding amount below this threshold can turn out to be ineffective in improving rigidity. Nevertheless, with too much talcum powder added, the filler has poor dispersion, adversely affect the molding processability and physical properties of the final product, and any adding amount greater than 20-wt % can undesirably increase the final product in specific weight. According to the present invention, the fine-particle-size inorganic powder is added in an amount of 10-20 wt %.

In the present invention, the high length-diameter ratio inorganic powder used is magnesium sulfate whisker, which is a single-crystal fiber. It has a length-diameter ratio of 10-60 or higher, but it has the optimal physical properties when the length-diameter ratio is 30-50. Whisker is close to perfect crystal, and has excellent mechanical properties such as high strength and high modulus, making them act as backbones in the polypropylene composition and be able to endow the composite with great strength. Whisker preferably has a small diameter because an increased diameter risks the whisker of more internal defects. Whisker with fewer defects has greater strength. For this reason, the whisker for strengthening purposes preferably has a high length-diameter ratio.

The inorganic powder used in the present invention has received surface treatment. To this end, the surface treatment agent used may be zinc stearate, titanate, silanes or other coupling agents. For the purpose of surface modification, the surface treatment agent is added in the amount equal to 3-4 wt % of the inorganic powder. The inorganic powder may be talcum, mica, or calcium carbonate. Alternatively, it may be whisker of an inorganic compound, such as silicon carbide, magnesium oxide, silicon oxide, magnesium sulfate, and calcium sulfate. With proper surface treatment or surface finish, it can have improved dispersion in organic resins, thereby enhancing processability and mechanical properties of the final product.

As used in the present invention, the masterbatch is made by mixing and co-extruding inorganic powder that has received surface treatment with a polypropylene resin using a twin-screw extruder. Therein, the inorganic powder is one or a combination of talcum powder and whisker. The fine-particle-size talcum powder is added in an amount of 10-20 wt %, and the whisker is added in an amount of 3-6 wt %. The polypropylene resin is a propylene-ethylene copolymer having a melt flow index (MI) of 30-60 g/10 min. and is added in an amount of 70-85 wt %.

In the present invention, the toughener used is rubber or a thermoplastic elastomer, for improving the polypropylene composition in terms of toughness. Therein, the rubber may be one or more selected from ethylene-propylene-diene monomer (EPDM), styrene-butadiene rubber (SBR), nitrile butadiene rubber (NBR) and ethylene-propylene rubber (EPR).

The thermoplastic elastomer may be one or more selected from ethylene-octene copolymer (POE), styrene-butadiene-styrene (SBS) and hydrogenated SBS (SEBS).

The toughener is well compatible to the polypropylene resin, so that the polypropylene composition so prepared has good balance between toughness and rigidity, allowing the polypropylene composition to show optimal properties.

The compatibilizer used in the present invention is a compatibilizer made by grafting polypropylene on maleic anhydride (PP-g-MA). To prepare the same, maleic anhydride (MA), polypropylene resin (PP) and dicumylperoxide (DCP) are weighted and mixed at high speed, before extruded by a twin screw extruder at 180 to 200° C. and granulated. The PP-g-MA has both a polar end (MA) and a non-polar end (PP), making it a good compatibilizer when MA is bound with the inorganic powder (polar) and PP has physical entanglement with polypropylene long chains (nonpolar) in the composition, so as to improve interfacial bonding between the inorganic powder and macromolecules.

In the present invention, the anti-oxidant used is one or a combination of a thermal antioxidant or an optical antioxidant. The thermal antioxidant may be CHINOX 1010, 1330 or B168 or a mixture with other anti-oxidants, and the optical antioxidant may be Chimassorb 2020, Tinuvin 770 or 783 or a mixture with other anti-oxidants.

The polypropylene composition of the present invention is made by mixing and co-extruding the polypropylene resin, the inorganic powder, the toughener, the coupling agent, the compatibilizer and the anti-oxidant using a twin screw extruder at 180-220° C. and 200-250 rpm, and cooling and granulating the extrudent. Therein, the inorganic powder may be in the form of a masterbatch premixed with the polypropylene resin, so as to be well distributed in the polypropylene composition, thereby significantly improving the composition in terms of toughness, rigidity and mobility.

The polypropylene composition of the present invention has excellent resistance to impact and to bonding, as well as has good mobility. Some examples and comparative examples described below are to explain the present invention but not intended to limit the scope of the present invention.

1. Preparation of the Compatibilizer (PP-g-MA):

To prepare the compatibilizer for the present invention, 5 parts by weight of maleic anhydride (MA), 100 parts by weight of polypropylene resin (PP), and 0.5 parts by weight of dicumyl peroxide (DCP) were mixed at high speed and extruded using a twin-screw extruder into grains at a temperature ranging between 180 and 200° C.

2, The polypropylene compositions made in Examples and Comparative Examples were tested for their physical properties using the following protocols, and the results are show in in Table 1:
1) The materials were tested for their weight ratios according to ISO1183 at 23° C. with de-ionized water and had their specific weights calculated.
2) The materials were tested for their flexural moduli according to ISO178 at 23° C. and a speed of 2 mm/min., with the distance to the support of 64 mm.
3) The materials were tested for their impact strength using a simply supported beam notch impact test according to ISO179 at 23° C. in the form of bar-shaped test pieces sized 80×10×4 mm and notched as stipulated.
4) The melt flow index (MI) was measured according to ISO1133 at 230° C. and with a load of 2.16 kg.

### Example 1

As shown in Table 1, Example 1 involves details described as follows:
1. 19 parts of fine-particle-size inorganic talcum powder (with an average grain diameter of 0.1-3 μm, and a loss on ignition of 8%), 4 parts of high length-diameter ratio inorganic magnesium sulfate whisker (with a diameter of 0.5-1.1 μm and a length of 15-30 μm) were mixed in a mixer at low speed. Then 0.7 parts of a silane coupling agent KBE-1003 (Shin-Etsu Chemical Co., Ltd.) was dropwise added the mixture, so that the mixture had its surface well treated in advance;
2. 23.7 parts of the pretreated inorganic powder of Step 1 and 35.55 parts of a high-melting-index polypropylene resin that is 1.5 time of the inorganic powder in weight (a propylene-ethylene copolymer having an MI of 50-60 g/10 min) were melted and co-extruded using a twin screw extruder into a masterbatch;
3. The masterbatch and 35.15 parts of the high-melting-index polypropylene, 3 parts of the low-melting-index polypropylene (a propylene-ethylene copolymer having an MI of 2-10 g/10 min.), 2 parts of the ethylene-octene copolymer elastomer toughener Engage 8150 (DOW CHEMICAL COMPANY), 0.5 parts of the compatibilizer (PP-g-MA) and 0.1 parts of the anti-oxidant CHINOXB 225 (Double Bond Chemical Ind., Co., Ltd.) were well mixed in a slow speed mixer and fed into the twin screw extruder at its charging hopper to be melted and co-extruded with the extruder set at 190/200/205/210/210/215/215/220° C. the die set at 220° C., the screw rotated at 200-250 rpm. The extrudent was cooled and granulated to obtain the high-toughness high-rigidity polypropylene composition.

### Example 2

The materials and the manufacturing method as mentioned in the description related to Example 1 were used, with the compositional proportions of the materials changed to 72.2 parts of high-melting-index polypropylene, 10 parts of low-melting-index polypropylene, 10 parts of fine-particle-size talcum powder, 6 parts of magnesium sulfate whisker, 0.5 parts of silane coupling agent, 1 parts of toughener, 0.2 parts of compatibilizer, 0.1 parts by weight of anti-oxidant, as shown in Table 1.

### Example 3

The materials and the manufacturing method as mentioned in the description related to Example 1 were used, with the compositional proportions of talcum powder and whisker changed to 13 parts and 3 parts, respectively, while the other components and corporations were identical to Example 2, as shown in Table 1.

### Example 4

The materials and the manufacturing method as mentioned in the description related to Example 1 were used, with the compositional proportions of the materials changed to 56.9 parts of high-melting-index polypropylene, 16 parts of low-melting-index polypropylene, 17 parts of talcum powder, 4 parts of magnesium sulfate whisker, 0.9 parts of silane coupling agent, 5 parts of toughener, 0.1 parts of compatibilizer, 0.1 parts of anti-oxidant, as shown in Table 1.

### Example 5

The materials and the manufacturing method as mentioned in the description related to Example 1 were used, with the compositional proportions of the materials changed to 56.6 parts of high-melting-index polypropylene, 16 parts of low-melting-index polypropylene, 17 parts of talcum powder, 4 parts of magnesium sulfate whisker, 0.9 parts of silane coupling agent, 5 parts of toughener, 0.4 parts of compatibilizer, 0.1 parts of anti-oxidant, as shown in Table 1.

### Comparative Example 1

The materials and the manufacturing method as mentioned in the description related to Example 1 were used, with the compositional proportions of the materials changed to 60.9 parts of high-melting-index polypropylene, 16 parts of low-melting-index polypropylene, 21 parts of talcum powder, 2 parts of ethylene-octene copolymer elastomer, 0.1 parts of anti-oxidant, as shown in Table 1. None of the magnesium sulfate whisker, the silane coupling agent and the compatibilizer PP-g-MA was added.

### Comparative Example 2

The materials and the manufacturing method as mentioned in the description related to Example 1 were used, with the compositional proportions of the materials changed to 65.9 parts of high-melting-index polypropylene, 13 parts of low-melting-index polypropylene, 17 parts of large-grain-diameter talcum powder (having an average grain diameter of 3-6 μm, and a loss on ignition of 8%), 4 parts of magnesium sulfate whisker, 0.1 parts of anti-oxidant, as shown in Table 1. None of the silane coupling agent, the ethylene-octene copolymer elastomer toughener and compatibilizer PP-g-MA was added.

### Comparative Example 3

The materials and the manufacturing method as mentioned in the description related to Comparative Example 2 were used, with the compositional proportions of the materials changed to 66.9 parts of high-melting-index polypropylene, 13 parts of low-melting-index polypropylene, 10 parts of large-grain-diameter talcum powder, 10 parts of magnesium sulfate whisker, 0.1 parts of anti-oxidant, as shown in Table 1.

TABLE 1

| | | Example | | | | | comparative Example | | |
|---|---|---|---|---|---|---|---|---|---|
| | | 1 | 2 | 3 | 4 | 5 | 1 | 2 | 3 |
| High-Melting-Index | | 70.7 | 72.2 | 72.2 | 56.9 | 56.6 | 60.9 | 65.9 | 66.9 |
| Polypropylene | | | | | | | | | |
| Low-Melting-Index | | 3 | 10 | 10 | 16 | 16 | 16 | 13 | 13 |
| Polypropylene | | | | | | | | | |
| Fine-Particle-Size | | 19 | 10 | 13 | 17 | 17 | 21 | — | — |
| Talcum Powder | | | | | | | | | |
| Large-Grain-Diameter | | — | — | — | — | — | — | 17 | 10 |
| Talcum Powder | | | | | | | | | |
| Magnesium Sulfate | | 4 | 6 | 3 | 4 | 4 | — | 4 | 10 |
| Whisker | | | | | | | | | |
| Silane Coupling Agent | | 0.7 | 0.5 | 0.5 | 0.9 | 0.9 | — | — | — |
| POE Elastomer | | 2 | 1 | 1 | 5 | 5 | 2 | — | — |
| PP-g-MA | | 0.5 | 0.2 | 0.2 | 0.1 | 0.4 | — | — | — |
| Anti-Oxidant | | 0.1 | 0.1 | 0.1 | 0.1 | 0.1 | 0.1 | 0.1 | 0.1 |
| Properties | Specific Weight | 1.05 | 1.00 | 1.01 | 1.04 | 1.04 | 1.05 | 1.04 | 1.03 |
| | Flexural Modulus | 2038 | 1911 | 1852 | 1832 | 1886 | 1624 | 1801 | 1904 |
| | Impact Strength | 40.2 | 45.1 | 40.7 | 55.8 | 52.0 | 39.6 | 31.7 | 30.1 |
| | Melt flow index | 30 | 34 | 34 | 28 | 28 | 28 | 29 | 22 |

Note:
1. The fine-particle-size talcum powder having an average grain diameter of 0.1-3 μm.
2. The large-grain-diameter talcum powder having an average grain diameter of 3-6 μm.
3. The whisker having a diameter 0.5-1.1 μm and a length 15-30 μm.
4. To make the masterbatch, the mixture of the talcum powder, the whisker and the silane coupling agent was mixed with the high-melting-index polypropylene at a weight ratio 1:1.5.

### Results:

1. As can be seen in Table 1, Examples 1-5 were lightweight, high-toughness, high-rigidity polypropylene compositions made according to the present invention. Example 1 reached the highest specific weight of 1.05, while having a flexural modulus higher than 2000 MPa, with a notch impact strength above 40 kJ/m², and a melt flow index of 30 g/10 min. While Example 2 was low in specific weight, as 1.00 its flexural modulus was still as high as 1911 MPa, while having an impact strength of 45.1 kJ/m², and a melt flow index of 34 g/10 min. All of the compositions of Examples 1-5 were made by first making the inorganic powder, the coupling agent, and the high-melting-index polypropylene into a masterbatch at a weight ratio of 1:1.5, and had improved impact strength and flexural moduli, demonstrating that the inorganic powder components, i.e. the talcum powder and the whisker, were well dispersed in the resulting polypropylene compositions.
2. In Comparative Examples 1-3, the compositions were made without using the coupling agent and the compatibilizer PP-g-MA, and thus their flexural moduli and impact strength could not be improved at the same time. As compared to Example 1, Comparative Example 1 used no whisker materials and only had talcum powder added for strengthening purposes, and that the overall rigidity was decreased, demonstrating that whisker is effective in improving rigidity by providing compositions with backbones. Comparative Example 2 eliminated the use of elastomers, and selected talcum powder having a grain diameter of 3-6 μm. Consequently, while its specific weight is equal to those of Examples 4 and 5, its flexural modulus and impact strength are clearly inferior. Comparative Example 3 increased the amount of the whisker, and while its rigidity is higher than the composition of Comparative Example 2, its overall physical properties is far inferior to those of the Examples.
3. The polypropylene compositions prepared using the method of the present invention do have both improved impact strength (toughness) and improved flexural moduli (rigidity), while having good mobility (processability) and low specific weights (lightweightness).

What is claimed is:

1. A lightweight, high-toughness, high-rigidity polypropylene composition, having a specific weight ranging between 1.0 and 1.05, and being characterized in having a flexural modulus at 23° C. of 1832-2038 MPa as measured according to standards as set forth in ISO178 and 179, and simply supported beam notch impact strength of 40.2-55.8 kJ/m², and being composed of the following components in amounts based on and jointly amount to 100 wt % of a total weight of the polypropylene composition:
a) a polypropylene resin taking up 70-85 wt % and comprising based on a total weight of the polypropylene resin:
a-1) 75-96% of a high-melting-index propylene-ethylene copolymer that has a melt flow index (MI) of 30-60 g/10 min. at 230° C. and with a load of 2.16 kg; and
a-2) 4-250 of a low-melting-index propylene-ethylene copolymer that has a melt flow index (MI) of 1-20 g/10 min. at 230° C. with a load of 2.16 kg;
b) inorganic powder taking up 10-20 wt % and having an average grain diameter ranging between 0.01 and 20 μm;
c) high length-diameter ratio magnesium sulfate whisker taking up 3-6 wt %, and having a length-diameter ratio of 10-60;
d) a toughener taking up 1-5 wt %;
e) a coupling agent taking up 0.5-1 wt %;
f) a compatibilizer taking up 0.2-0.5 wt %, and being one made by grafting polypropylene on maleic anhydride; and
g) an anti-oxidant taking up 0.1-0.2 wt %.

2. The polypropylene composition of claim 1, wherein the high-melting-index propylene-ethylene copolymer and the low-melting-index propylene-ethylene copolymer each has a content of comonomer ethylene ranging between 1% and 10%.

3. The polypropylene composition of claim 1, wherein the inorganic powder is talcum powder having an average grain diameter of 0.1-3 μm.

4. The polypropylene composition of claim 1, wherein the inorganic powder is inorganic compound whisker that has received surface treatment, and is whisker of one or more selected from silicon carbide, magnesium oxide, silicon oxide and calcium sulfate.

5. The polypropylene composition of claim 1, wherein the toughener is one or more selected from ethylene-propylene-diene monomer (EPDM), styrene-butadiene rubber (SBR), nitrile butadiene rubber (NBR), ethylene-propylene rubber (EPR), ethylene-octene copolymer (POE), styrene-butadiene-styrene (SBS) and hydrogenated SBS (SEBS).

6. The polypropylene composition of claim 1, wherein the anti-oxidant is one or a combination of a thermal antioxidant and an optical antioxidant.

7. The polypropylene composition of claim 6, wherein the thermal antioxidant is selected from CHINOX 1010, 1330 and B168.

8. The polypropylene composition of claim 6, wherein the optical antioxidant is selected from Chimassorb 2020, Tinuvin 770 and 783.

9. A method of manufacturing polypropylene compositions of claim 1, comprising the following steps:
1) at low speed mixing fine-particle-size inorganic powder with high length-diameter ratio inorganic powder in a mixer into a mixture, and dropwise adding a coupling agent to the mixture to well treat the surface of the mixture;
2) introducing the pretreated inorganic powder of step 1) with a high-melting-index polypropylene resin by weight of 1.5 times of the inorganic powder into a twin-screw extruder to produce a masterbatch; and
3) well mixing the masterbatch of step 2) with an additional high-melting-index polypropylene, a low-melting-index polypropylene, a toughener, a compatibilizer and an anti-oxidant in a slow-speed mixer and through a twin-screw extrude to obtain a polypropylene composition having a good balance among lightweightness, toughness and rigidity.
